(19) United States
(12) Patent Application Publication
(10) Pub. No.: US 2024/0428408 A1
(43) Pub. Date: Dec. 26, 2024

(54) AUTOMATIC AND PARALLEL ANALYSIS OF MICROARRAY IMAGES

(71) Applicant: SQI DIAGNOSTICS SYSTEMS INC., Toronto, Ontario (CA)

(72) Inventors: Eric BROUWER, York (CA); Simeng CHEN, Shenzhen (CN); Pierre SULLIVAN, North York (CA)

(21) Appl. No.: 18/707,904

(22) PCT Filed: Nov. 7, 2022
(86) PCT No.: PCT/CA2022/051645

§ 371 Date: May 7, 2024

Related U.S. Application Data
(60) Provisional application No. 63/276,803, filed on Nov. 8, 2021.

(51) Int. Cl. G06T 7/00; G06T 3/60; G06T 7/12; G06T 7/149; G06T 7/60; G06T 7/73

(52) U.S. Cl. CPC G06T 7/0012; G06T 3/60; G06T 7/12; G06T 7/149; G06T 7/60; G06T 7/73; G06T 2207/10064; G06T 2207/20021; G06T 2207/20116; G06T 2207/30072; G06T 2207/30204

(57) ABSTRACT

A method for analyzing microarray images in an automatic and parallel fashion is provided. Optimal gridding is achieved by an automatic and robust identification of fiducial marker spots, even if spots are of poor quality, poorly imaged and/or there is rotation or shifting of the well. Spot region is correctly captured through an active-contour image segmentation without an estimate of spot size. The circularity of spot regions is used as a crucial indicator of spot quality. Spots of poor quality are identified as outliers when the circularity is below a threshold. Parallel computing is utilized to accelerate the image analysis.

### TECHNICAL FIELD

The application is directed generally to multiplex immunoassays for detecting the presence of biological protein markers in a biological matrix. In particular, the application is directed to the analysis of positional microarray images of multiplex immunoassay detection zones and to the measuring of microarray image signal intensities in an automatic and parallel fashion.

### BACKGROUND OF THE INVENTION

Microarray technology represents a multiplex immunoassay platform which allows for the simultaneous assessment of concentrations of different biomarkers. Design and development of microarrays requires a rigorous understanding of the underlying physics and chemistry of crucial processes such as printing, curing, assay binding kinetics, etc. The printing of biological and chemical materials on an optically-transparent substrate in an array pattern creates a positional microarray. The manufacturing of test plates requires the dispensing of droplets containing the appropriate analyte detection materials to designated locations, blocking unbound active sites that did not receive dispensed analyte detection materials, and curing and stabilization of printed dried spots which may be circular or other geometrical shapes such as squares for example. Assay test plates are produced having a plurality of separate wells. Each well contains multiple sensor spots which detect the concentrations of different proteins in a biological sample. Assay tests are run by loading a sample to isolated wells of a plate, performing mechanical shaking of a plate, washing, adding fluorophore-containing proteins to bind to specific biomarkers, and then drying the final plate. Each well is then scanned to record the fluorescence intensities of sensor spots. Scanning produces the raw images for subsequent image processing which converts an array image into readout signals.

The intensity measurement of sensor spots within each plate well requires an initial preliminary estimation of sensor spot locations. An estimation can be achieved by a method known as gridding. The process of gridding locates grid lines which divide a microarray of sensor spots into individual cells. Ideally each cell contains at most one spot. Gridding creates a reference of spot locations so that any spot within the grid can be located using row and column indices. A number of unsupervised/automatic gridding algorithms have been proposed using a variety of approaches (Shao G, Li D, Zhang J, Yang J, Shangguan Y (2019) Automatic microarray image segmentation with clustering-based algorithms. PLOS ONE 14 (1): e0210075 https://doi.org/10.1371/journal.pone.0210075). Although unsupervised gridding methods are capable of yielding optimal gridding results without or with very little human intervention, they are often computationally expensive, and their functionality drops dramatically when dealing with irregular microarrays. As a result, most commercial software (e.g., ScanAlyze, ImaGene, SpotFinder etc.) adopts supervised gridding methods which require several user-input parameters and the presence of fiducial marker (FM) spots for referencing. Furthermore, since standard microarray products have well-defined array metrics (such as the number of rows and columns, spot distance etc.), the benefit of less human intervention using unsupervised gridding is not cost-efficient. The advantage of fast processing speed and high functionality makes supervised gridding more favorable in industrial practice. Standard approaches may fail to detect FM spots if the FM spots are of poor quality (e.g., damaged/missing), poorly imaged and/or there is rotation, yawing, rolling or shifting of the well. These poor quality attributes impact subsequent analysis of microarray spots. There is a need for a method wherein optimal gridding is achieved by an automatic and robust identification of FM spots in microarray images.

The signal of a sensor spot may be reported as the Mean Fluorescence Intensity (MFI) within the spot region. The signal of a sensor spot may also be measured by other methods known by a person skilled in the art such as colorimetric or chemiluminescence. It is crucial to correctly identify the spot edge in order to obtain an accurate intensity measurement. One option is to use a fixed measuring circle defined by user input resulting in an estimate of spot size to capture the spot region, potentially imposing a systematic error on MFI. The size of the fitting circle is a user-input parameter and constant for all spots across the plate. In industrial manufacturing, spots produced from the same volume may form various spot sizes due to different fluid and surface properties. Current fixed-size spot-finding routines include background subtraction. Background subtraction routines are widely used to process microarray data. For high MFI spots, subtracting the background has very little impact on the accuracy of the intensity measurement, as the spot intensity is much greater than the background intensity. For low MFI spots, the magnitude of background intensity may be comparable to the spot intensity, and the imprecision of both signal and background intensities can lead to inaccurate MFI measurements. A robust spot-finding method is needed to correctly capture spot region without using an approach which estimates spot size and utilizes background subtraction. There is a need for a method wherein spot region is correctly captured through an active-contour image segmentation.

Although many spot metrics are known in the art, such as spot standard deviation and spot area, these are not indicators of spot quality. Spots of low quality may impact final analytical result accuracy by falsely lowering or falsely raising MFI signal intensity from true or expected MFI intensity. Low-quality spots may impact final analytical result accuracy throughout the range of spot intensity, from low to high intensity. An approach wherein spots of low quality are identified as outliers is needed.

Using a standard process by central processing unit (CPU), sequential computation, the analysis time of a standard 96-well assay plate takes approximately 15 minutes. For a 384-well assay plate, it takes 60 minutes, and for a 1536-well assay plate, it takes 4 hours. The linear growth of analysis time has become a challenge for the design of high-throughput microarray assay plates. A faster image analysis is needed, particularly when there is a need to rapidly deliver clinical results to the end user. Despite their original and obvious use of rendering 3D objects in video games, Graphics Processing Units (GPU) have attracted increasing attention of scientists and engineers for their general-purpose parallel computations using platforms such as OpenCL and CUDA. The parallel processing of high-throughput images series is one of the most important applications of GPU computation. The reasons are as follows: a) the majority of image processing operations involve iterations from pixel to pixel, which facilitates the simultaneous execution of independent pixel operations through GPU; b) the hardware architecture is well designed for graphical purposes, thus the accessing of pixel values is fast and manipulation of pixels is optimized.

There is a need for a method wherein parallel computing is utilized to accelerate the image analysis. A simultaneous analysis of multiple microarray images through GPU parallel computing is needed to overcome the timing challenges of standard processing.

### SUMMARY

Described is a fast and efficient method for the analysis of microarray images that includes the following aspects:
1. Fiducial marker (FM) spots detection for optimal gridding;
2. Image segmentation for optimal sensor spot finding;
3. Circularity quality checks for optimal post-processing of data; and
4. Parallel analysis for fast analysis.

According to one aspect of the present disclosure, there is provided a method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps: providing a fluorescent material that binds to the fiducial marker spots, the fiducial marker spots comprising a material which causes the fiducial marker spots to have a detectable fluorescent intensity when contacted with the fluorescent material; generating an image of the microarray substrate; adding visible lines in the form of a grid on the image such that the grid forms a plurality of individual cells, the cells being sized to contain at most one sensor spot or fiducial marker spot; dividing the image into four user defined zones, a first user defined zone being an upper left zone of the image, a second user defined zone being an upper right zone of the image, a third user defined zone being a lower right zone of the image, and a fourth user defined zone being an lower left zone of the image; searching for the detection of fiducial marker spots in each of the user defined zones; determining the detection of a fiducial marker spot in each of the user defined zones whereby an imaginary line connecting the four fiducial markers spots detected meets a user defined shape, the user defined shape being a perfect square; and determining the location of a boundary around the analysis zone based on the location of the fiducial marker spots.

According to another aspect of the present disclosure, there is provided a method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps: providing a fluorescent material that binds to the fiducial marker spots, the fiducial marker spots comprising material which causes the fiducial marker spots to have a detectable fluorescent intensity when contacted with the fluorescent material; generating an image of the microarray substrate; adding visible lines in the form of a grid on the image such that the grid forms a plurality of individual cells, the cells being sized to contain at most one sensor spot or fiducial marker spot; dividing the image into four user defined zones, a first user defined zone being an upper left zone of the image, a second user defined zone being an upper right zone of the image, a third user defined zone being a lower right zone of the image, and a fourth user defined zone being an lower left zone of the image; searching for the detection of fiducial marker spots in each of the user defined zones, whereby one fiducial marker spot is located in each of three of the four user defined zones and a fiducial marker spot and an artifact spot are detected in one of the four of the user defined zones; determining which of the fiducial marker spot and an artifact spot detected in the one of the four of the user defined zones is a true fiducial marker spot according to the following steps: drawing two possible quadrilaterals by connecting with an imaginary line the spots in each user defined zone with the spots in the other user defined zones with the rule that spots in a single user defined zone cannot be connected; determining which of the two quadrilaterals has a lower residual error relative to a predefined threshold set based on known tolerances of the manufacturing equipment used to produce the microarray; selecting the spot in the one of the four of the user defined zones being part of the quadrilateral that has a lower residual error as the true fiducial marker spot; and determining the location of a boundary around the analysis zone based on the location of the fiducial marker spots detected and the true fiducial marker spot determined.

According to another aspect of the present disclosure, there is provided a method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps:
providing a fluorescent material that binds to the fiducial marker spots, the fiducial marker spots comprising material which causes the fiducial marker spots to have a detectable fluorescent intensity when contacted with the fluorescent material; generating an image of the microarray substrate; adding visible lines in the form of a grid on the image such that the grid forms a plurality of individual cells, the cells being sized to contain at most one sensor spot or fiducial marker spot; dividing the image into four user defined zones, a first user defined zone being an upper left zone of the image, a second user defined zone being an upper right zone of the image, a third user defined zone being a lower right zone of the image, and a fourth user defined zone being an lower left zone of the image; searching for the detection of fiducial marker spots in each of the user defined zones, whereby one fiducial marker spot is located in each of three of the four user defined zones and no fiducial marker spot is detected in one of the four of the user defined zones; assigning a location of a projected fiducial marker spot in the one of the four of the user defined zones where no fiducial marker spot is detected by drawing a parallelogram connecting the fiducial marker spots located in the three of the four user defined zones and the projected fiducial marker spot according to the parallelogram rule; and determining the location of a boundary around the analysis zone based on the location of the fiducial marker spots detected and the projected fiducial marker spot.

According to another aspect of the present disclosure, there is provided a method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps: providing a fluorescent material that binds to the fiducial marker spots, the fiducial marker spots comprising material which causes the fiducial marker spots to have a detectable fluorescent intensity when contacted with the fluorescent material; generating an image of a portion microarray substrate comprising the analysis zone; adding visible lines in the form of a grid on the image such that the grid forms a plurality of individual cells, the cells being sized to contain at most one sensor spot or fiducial marker spot; dividing the image into four user defined zones, a first user defined zone being an upper left zone of the image, a second user defined zone being an upper right zone of the image, a third user defined zone being a lower right zone of the image, and a fourth user defined zone being a lower left zone of the image; searching for the detection of fiducial marker spots in each of the user defined zones, whereby one fiducial marker spot is detected in each of three of the four user defined zones and an artifact spot is detected in one of the four user defined zones; iteratively, for each of the four user defined zones, deactivating the spot of the user defined zone according to the following steps: deactivating the spot detected in the user defined zone and assigning a location of a projected fiducial marker spot in the user defined zone where the spot is deactivated; connecting with an imaginary line the three spots of the non-deactivated user defined zones with the projected fiducial marker spot to form a quadrilateral; calculating a fitting error of the quadrilateral based on a comparison of the shape of the quadrilateral formed by the imaginary line to an expected predefined perfect square; and comparing the fitting error to a predefined threshold wherein the predefined threshold is set based on known tolerances of the manufacturing equipment used to produce the microarray; calculating among quadrilaterals generated iteratively, a quadrilateral with a fitting error that is lower than the predefined threshold; selecting a projected fiducial marker spot of a quadrilateral with a fitting error that is lower than the predefined threshold as being a true fiducial marker spot and disregarding a spot detected in a user defined zone of the selected projected fiducial marker spot as being an artifact; and determining the location of a boundary around the analysis zone based on the location of the fiducial marker spots detected and a projected fiducial marker spot.

According to another aspect of the present disclosure, the fitting error is calculated according to the following steps:
assigning coordinates (x₁, y₁), to the fiducial marker spot in the first user defined zone, assigning coordinates (x₂, y₂) to the fiducial marker spot in the second user defined zone, assigning coordinates (x₃, y₃) to the fiducial marker spot in the third user defined zone, and assigning coordinates (x₄, y₄) to the fiducial marker spot in the fourth user defined zone in a cartesian coordinate system; calculating four side lengths L₁₂, L₂₄, L₃₄, L₁₃ and two diagonal lengths L₁₄, L₂₃ of a quadrilateral formed by connecting the four fiducial marker spots as follows:

$${L}_{12} = \sqrt{{( {x}_{1} - {x}_{2} )}^{2} + {( {y}_{1} - {y}_{2} )}^{2}} , \\ {L}_{24} = \sqrt{{( {x}_{2} - {x}_{4} )}^{2} + {( {y}_{2} - {y}_{4} )}^{2}} , \\ {L}_{34} = \sqrt{{( {x}_{3} - {x}_{4} )}^{2} + {( {y}_{3} - {y}_{4} )}^{2}} , \\ {L}_{13} = \sqrt{{( {x}_{1} - {x}_{3} )}^{2} + {( {y}_{1} - {y}_{3} )}^{2}} , \\ {L}_{14} = \sqrt{{( {x}_{1} - {x}_{4} )}^{2} + {( {y}_{1} - {y}_{4} )}^{2}} , \\ {L}_{23} = \sqrt{{( {x}_{2} - {x}_{3} )}^{2} + {( {y}_{2} - {y}_{3} )}^{2}} ;$$

calculating a sum of squared differences of lengths between the quadrilateral and a predefined perfect square with side length a according to the following formula:

$${\sum }_{i} {( Δ {L}_{i} )}^{2} = {( {L}_{12} - a )}^{2} + {( {L}_{24} - a )}^{2} + {( {L}_{34} - a )}^{2} + {( {L}_{13} - a )}^{2} + {( {L}_{14} - \sqrt{2} a )}^{2} + {( {L}_{23} - \sqrt{2} a )}^{2} ;$$

and
calculating a sum of squared differences of lengths of the lines of the quadrilateral to obtain the fitting error according to the following formula:

$$Err = \frac{{{Σ}_{i} ( Δ {L}_{i} )}^{2}}{4 \times {a}^{2} + 2 \times {( \sqrt{2} a )}^{2}} = \frac{{{Σ}_{i} ( Δ {L}_{i} )}^{2}}{8 {a}^{2}} .$$

According to another aspect of the present disclosure, there is provided a method of identifying a spot edge contour of a sensor spot printed on a microarray substrate such that both a variation of pixel intensities inside a contour of a curve C and a variation of pixel intensities outside the curve C are minimized for measuring a Mean Fluorescence Intensity (MFI) of the sensor spot within the contour comprising the following steps: providing a fluorescent material that binds to the sensor spots, the sensor spots comprising a material which causes the sensor spots to have a detectable fluorescent intensity when contacted with the fluorescent material; generating an image of the microarray substrate; applying the curve C around the image of the sensor spot wherein region inside the curve C represents a sensor spot region while the region outside the curve C denotes a background region; defining the contour of the curve C as Φ(x, y) being defined as a signed distance function from C, where the value of Φ(x, y) is positive inside the curve C and is negative outside the curve C;
applying a level set formulation according to the following steps: calculating an energy functional F(C) in terms of Φ(x, y) only (v=0) as follows:

$$F ( Φ ) = μ \cdot \int δ ( Φ ( x , y ) ) \vert ∇ Φ ( x , y ) \vert dxdy + {λ}_{1} \int {\vert {u}_{0} ( x , y ) - {c}_{1} \vert}^{2} H ( Φ ( x , y ) ) dxdy + {λ}_{2} \int {\vert {u}_{0} ( x , y ) - {c}_{2} \vert}^{2} ( 1 - H ( Φ ( x , y ) ) ) dxdy , \\ {c}_{1} = \frac{\int {u}_{0} ( x , y ) H ( Φ ( x , y ) ) dxdy}{\int H ( Φ ( x , y ) ) dxdy} , \\ {c}_{2} = \frac{\int {u}_{0} ( x , y ) ( 1 - H ( Φ ( x , y ) ) ) dxdy}{\int ( 1 - H ( Φ ( x , y ) ) ) dxdy} ,$$

where δ(x) is the Dirac delta function and H(z) denotes the Heaviside function:

$$H ( z ) = \{ \begin{matrix}1 ( z \geq 0 ) \\ 0 ( z < 0 )\end{matrix}$$

wherein given an initial Φ(x, y, 0)=Φ₀(x, y), an evolution of Φ(x, y, t) which minimizes the energy functional F(C) is governed by a partial differential equation (PDE) using Euler-Lagrange equations and the gradient-descent method (t is an artificial time):

$$\frac{\partial Φ}{\partial t} = δ ( Φ ) ( μ \cdot div ( \frac{∇ Φ}{\vert ∇ Φ \vert} ) - {{λ}_{1} ( {u}_{0} - {c}_{1} )}^{2} + {{λ}_{2} ( {u}_{0} - {c}_{2} )}^{2} ) = δ ( Φ ) ( μ \cdot κ ( Φ ) - {{λ}_{1} ( {u}_{0} - {c}_{1} )}^{2} + {{λ}_{2} ( {u}_{0} - {c}_{2} )}^{2} ) , \\ Φ ( x , y , 0 ) = {Φ}_{0} ( x , y ) ,$$

where κ(Φ) represents the curvature of evolving contour C:

$$κ ( Φ ) = \frac{{Φ}_{xx} {Φ}_{y}^{2} - 2 {Φ}_{xy} {Φ}_{x} {Φ}_{y} + {Φ}_{yy} {Φ}_{x}^{2}}{{( {Φ}_{x}^{2} + {Φ}_{y}^{2} )}^{3 / 2}} ;$$

and
determining the contour of the curve C as a zero level set of Φ(x, y);
applying an iterative process using a Chan-Vese active-contour algorithm which specializes in the partition of images without clear edges by evolving Φ(x, y, t) a plurality of times until a convergence criterion is reached, wherein the curve C shows boundaries where Φ(x, y, t) equals zero; and
calculating the sensor spot MFI as the average pixel intensities of a foreground region within the contour of the curve C.

According to yet another aspect of the present disclosure, there is provided a method of processing images of sensor spots printed on a microarray substrate wherein the sensor spots emit light pixels for detection of the sensor spots, said method comprising the following steps: employing a central processing unit (CPU) for detecting a sensor spot region containing the sensor spots to be analyzed through a gridding algorithm; segmenting microarray images of the sensor spots into individual sub images with a same dimension wherein each sub image contains a sensor spot and a background of the sensor spot; stacking the sub images into an array of 2D images with a depth of a total number of sensor spots; in parallel constructing another 3D array with the same dimension using a pre-defined identical initial level set Φ₀(x, y) wherein Φ(x, y) is defined as the signed distance function from C, where the value of Φ(x, y) is positive inside C and negative outside C, C being a circular curve around the sensor spot; and transferring constructed 3D arrays of both sensor spots and initial level set Φ₀(x, y) using a CPU program to a graphic processing unit (GPU) device.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is an example of a sensor microarray image of a square well containing sensor spots and four FM spots;

FIG. 2 is an illustration of a method of spot MFI measurement through a user-defined fixed circle;

FIG. 3 is a flowchart of robust FM spots detection;

FIG. 4 is an example of four square User Defined Zones (UDZ) and four circular FM spots;

FIG. 5 is an example of an abnormal scenario where multiple FM spots (including ‘true’ FM spot and artifacts) are detected within a UDZ;

FIG. 6A is an example of an abnormal scenario where zero FM spots are detected within a UDZ;

FIG. 6B is an example of an abnormal scenario where zero FM spots are detected within a UDZ and a projected FM spot is added to the UDZ where zero FM spots were detected;

FIG. 7A is an example of an abnormal scenario where an artifact is detected as a FM spot in an UDZ while the ‘true’ FM spot is missing within the UDZ;

FIG. 7B is an example of the implementation of an iterative process referred to in step 9 of FIG. 3 whereby an upper left UDZ is inactivated and an imaginary FM is restored using the locations of the FMs in the other three UDZs according to a parallelogram rule;

FIG. 7C is an example of the implementation of the iterative process whereby an upper right UDZ is inactivated, and an imaginary FM is restored using the locations of the FMs in the other three UDZs according to a parallelogram rule;

FIG. 7D is an example of the implementation of the iterative process whereby a lower left UDZ is inactivated and an imaginary FM is restored using the locations of the FMs in the other three UDZs according to a parallelogram rule;

FIG. 7E is an example of the implementation of the iterative process whereby a lower right UDZ is inactivated and an imaginary FM is restored using the locations of the FMs in the other three UDZs according to a parallelogram rule;

FIG. 8A is a schematic showing the calculation of a fitting error in a case of four FM spots;

FIG. 8B is an illustration of a predefined square employed in the error calculation;

FIG. 9A is an illustration of a rotation check and correction of a microarray;

FIG. 9B is an illustration of a rotated microarray;

FIG. 10 is a series of images illustrating a spot-finding process through an iterative Chan-Vese algorithm;

FIG. 11 is an example of a signed distance function and its zero level set (a circle);

FIG. 12A is a raw image of a damaged sensor spot;

FIG. 12B is an illustration of a segmentation result in a raw image of a damaged sensor spot;

FIG. 12C is an illustration of an overlapped area between a sensor spot and a fitting circle in a raw image of a damaged sensor spot;

FIG. 13A is a demonstration of a good spot;

FIG. 13B is a demonstration of a damaged spot;

FIG. 13C is a demonstration of a comet spot;

FIG. 13D is a demonstration of another defect spot;

FIG. 14A is an illustration of a prior art spot detecting system

FIG. 14B is an illustration of the circularity check system of the present disclosure;

FIG. 15 is an example of the construction of 3D spot image of a 96-well plate;

FIG. 16 is an overview of the workflow of a parallel analysis of 3D spot image;

FIG. 17A is a demonstration of tested results where the computation time (data points, left vertical axis) is plotted as a function of well number; and

FIG. 17B is a demonstration of tested results where speedup factor (solid lines and dashed lines, right vertical axis) is plotted as a function of well number.

### DETAILED DESCRIPTION

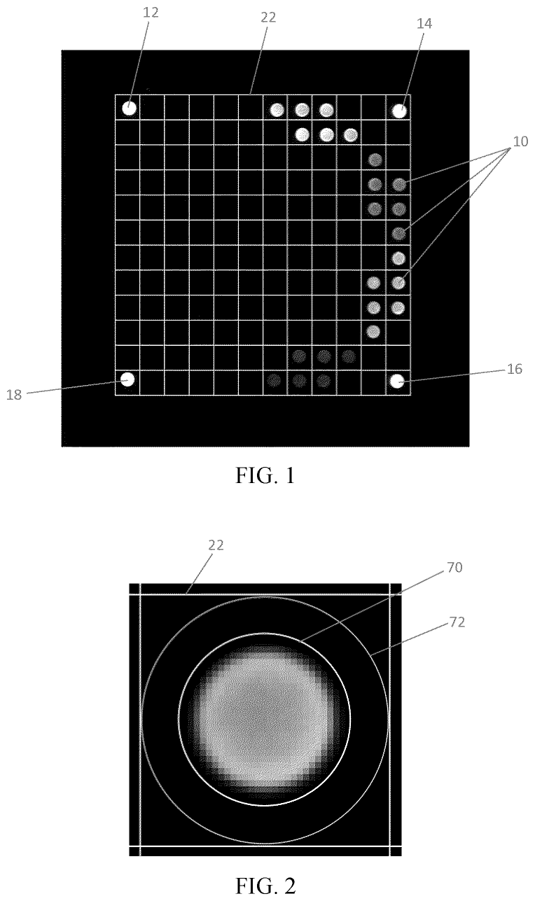

FIG. 1 is an image of an array of sensor spots 10 and circular fiducial marker (FM) spots 12, 14, 16, 18 in a single well of a 96-well assay plate. A grid 22 is superimposed upon the image. This provides an example of gridding. In the example shown in FIG. 1, the four FM spots 12, 14, 16, 18 are located at the corners of the grid 22. A set of sensor spots 10 are also located within the grid. Sensor spots typically contain antibodies or other biological materials such as proteins that bind to a biological marker to be detected.

A fiducial marker is a well-defined geometric feature, such as a circular spot or a square mark, that has a centroid or an edge property. The fiducial marker can be detected by optical methods. In the discussion below, specific examples of a circular fiducial marker, or fiducial marker spot is the representative geometrical feature.

FM spots act to orient the grid for analysis which may be referred to as an Analysis Zone. The FM spots are printed at the same time as the sensor spots but generally with higher fluorescence ensuring ease of detection using optical methods.

The FM spots allow geometric extremes of the Analysis Zone to be defined. In the example shown in FIG. 1, the centroid features of four FM spots 12, 14, 16, 18 are used to define a square region as the Analysis Zone. Once the centroid of each FM spot is determined, it is possible to define vertical and horizontal extrema for the Analysis Zone. In the example shown in FIG. 1, square gridding is employed, and the four corner FM spots 12, 14, 16, 18 are defined at the beginning of the image analysis process. Gridding allows the segmentation of the Analysis Zone into defined uniform areas or cells (squares in FIG. 1) which serve to isolate the expected location of individual sensor spots. The sensor spots can then be analyzed using image analysis.

FIG. 2 shows detail of one of the sensor spots in FIG. 1, with a super-positioning of one of the square cells of the grid 22. A user-defined fixed inner circle 70 is superimposed on the image and the interior of the circle represents the region of interest from which spot signal intensity data are collected. A user-defined fixed outer circle 72 is also superimposed on the image. Background signal intensity data are collected from the area between the inner and outer circles.

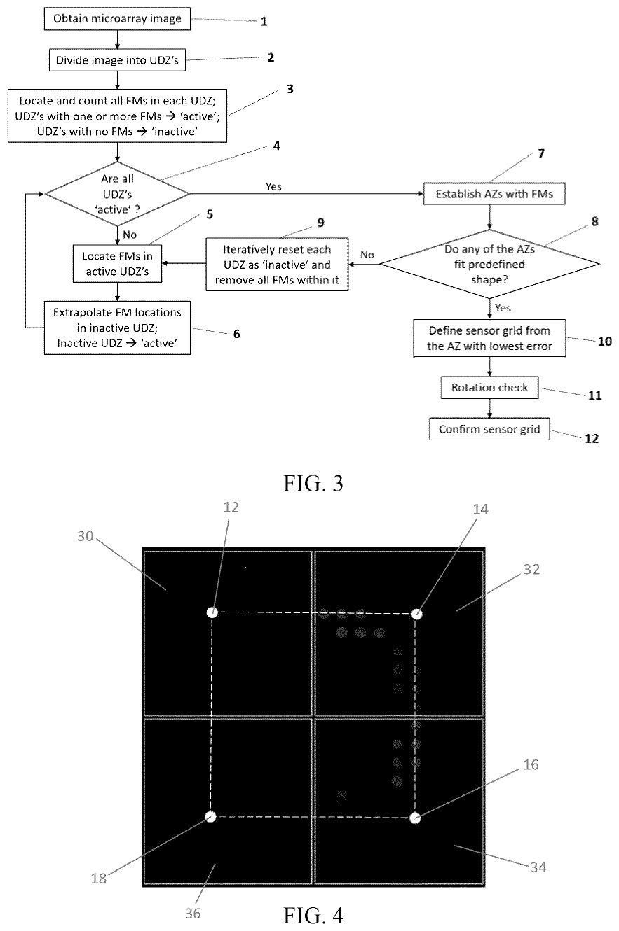

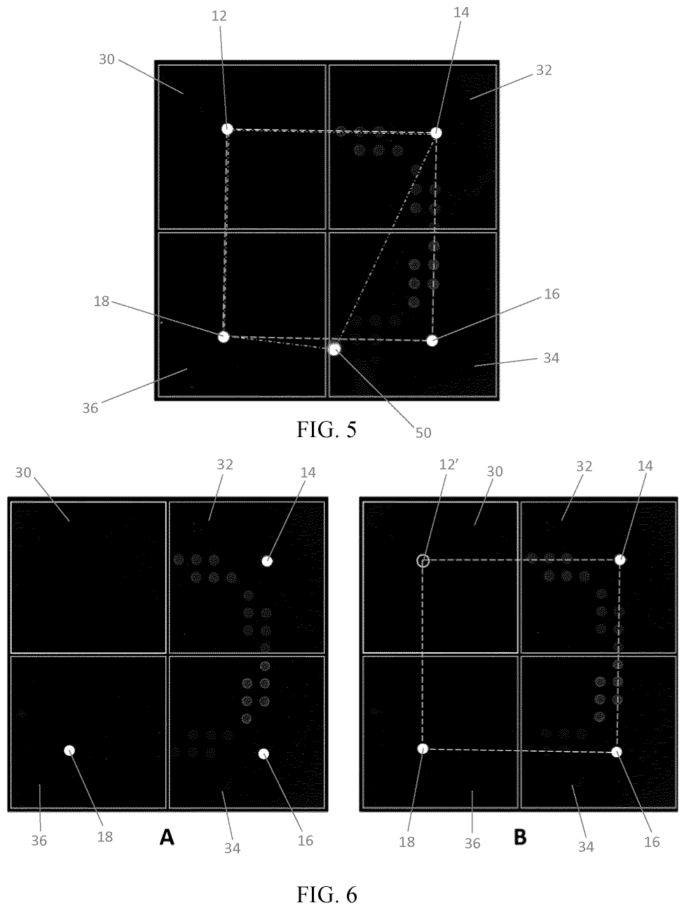

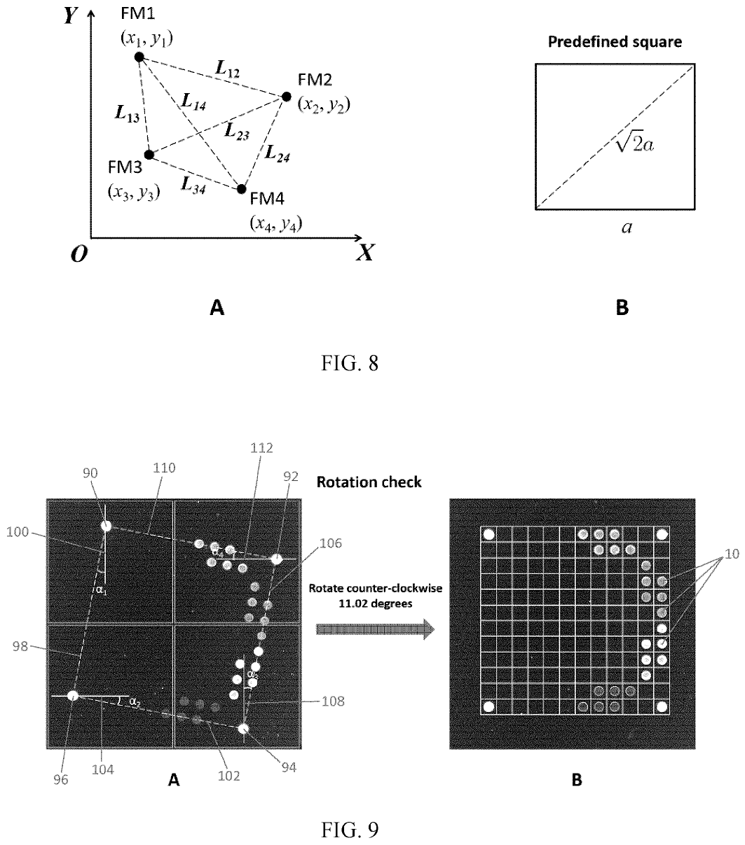

FIG. 3 shows a flowchart of robust FM spot detection. The steps are as follows:
1. Obtain a microarray image.
2. The input microarray image is divided into four User-Defined Zones (UDZs) 30, 32, 34, 36 as shown in FIG. 4.
3. Locate and count all FM spots in each User-Defined Zone. FIG. 4 illustrates the case in which all FM spots 12, 14, 16, 18 are detected within each User-Defined Zone.
   If the number of FM spots detected is equal to or greater than one for a User-Defined Zone, the UDZ is deemed ‘active’. If the number of FM spots detected is zero for a User-Defined Zone, the UDZ is deemed ‘inactive’.
4. If all UDZ's are active proceed to step 7. If not, proceed to step 5.
5. Locate FM spots in the active UDZ's.
6. Extrapolate FM locations in the inactive UDZ and reset UDZ as ‘active’. Then proceed to step 4
7. Establish the shape of each Analysis Zone (AZ) formed by every combination of FM spots. FIG. 5 depicts a microarray image with two Analysis Zones indicated by dashed lines.
8. Fit each Analysis Zone shape against a user-defined shape and assess the fit. If the fit meets the user-defined shape criteria, continue to step 10. The user-defined shape is preferably a perfect square as shown in FIG. 8B.
9. Iteratively reset each UDZ as “inactive” and remove all FMs within it. If an AZ shape does not fit the user-defined shape, remove the excess FM spots and label corresponding UDZ's as ‘inactive’. Then go to step 5.
10. Define sensor grid from AZ with the lowest error. The grid is checked against the AZ shape that most closely matches the user-defined shape. If the grid does not match, missing FM spots are interpolated to properly define the shape. See FIG. 6.
11. Rotation check. The grid is rotated to align with a vertical and horizontal axis. See FIG. 9.
12. Confirm sensor grid. The grid is defined for analysis.

When FM spots are falsely identified and/or missing, the ability to define the correct Analysis Zone is compromised and inaccurate image processing may proceed, or the sequence of image processing steps may terminate. Below, mitigations to these limitations are described and discussed.

FIG. 4 is a microarray image of four square User Defined Zones (UDZ) 30, 32, 34, 36 and four circular FM spots 12, 14, 16, 18, each located in one of the respective UDZs 30, 32, 34, 36. The image can represent a well of an assay plate.

FIG. 5 is a microarray image of four FM spots 12, 14, 16, 18 and an artifact 50. The image is divided into four User-Defined Zones 30, 32, 34, 36. A first fiducial marker spot 12 is detected at the upper left User-Defined Zone 30. A second fiducial marker spot 14 is detected at the upper right User-Defined Zone 32, a third fiducial marker spot 16 is detected at lower right User-Defined Zone 34 and a fourth fiducial marker spot 18 is detected at lower left User-Defined Zone 36 of the image. An artifact 50 is also detected near the lower right of the image. Fiducial marker spot 16 is the ‘true’ fiducial marker spot while the circular artifact 50 is an artifact potentially arising from a manufacturing defect of the assay plate. The presence of the artifact 50 results in two possible quadrilaterals which are formed by one set of spots: fiducial marker spot 12, fiducial marker spot 14, fiducial marker spot 16 and fiducial marker spot 18, and another set of spots: fiducial marker spot 12, fiducial marker spot 14, circular artifact 50 and fiducial marker spot 18. Both quadrilaterals are fitted to a square predefined by the user, with a rule that multiple spots in a single UDZ cannot be connected. The quadrilateral formed by fiducial marker spot 12, fiducial marker spot 14, fiducial marker spot 16 and fiducial marker spot 18 has a lower residual error. Therefore fiducial marker spot 12, fiducial marker spot 14, fiducial marker spot 16 and fiducial marker spot 18 are identified as final FM spots while the quadrilateral of fiducial marker spot 12, fiducial marker spot 14, circular artifact 50 and fiducial marker spot 18 is rejected due to a high error.

FIG. 6A is an image of a single well of an assay device comprising three FM spots. The image is divided into four User-Defined Zones 30, 32, 34, 36. Fiducial marker spot 14 is detected in the User-Defined Zone 32, fiducial marker spot 16 is detected in the User-Defined Zone 34, and fiducial marker spot 18 is detected in the User-Defined Zone 36. No fiducial marker spot is detected in the User-Defined Zone 30. Thus, as shown in FIG. 6B, the User-Defined Zone 30 at the upper left is deactivated and projected spot 12′ is added to zone 30 using the locations of the other three spots 14, 16, 18 from active zones 32, 34, 36 based on the parallelogram rule (the sum of the squares of the lengths of the four sides of a parallelogram equals the sum of the squares of the lengths of the two diagonals). In this specific case, the shape formed by 12′, 14, 16, 18 follows a parallelogram. Then the quadrilateral of 12′, 14, 16, 18 is fitted to a predefined square.

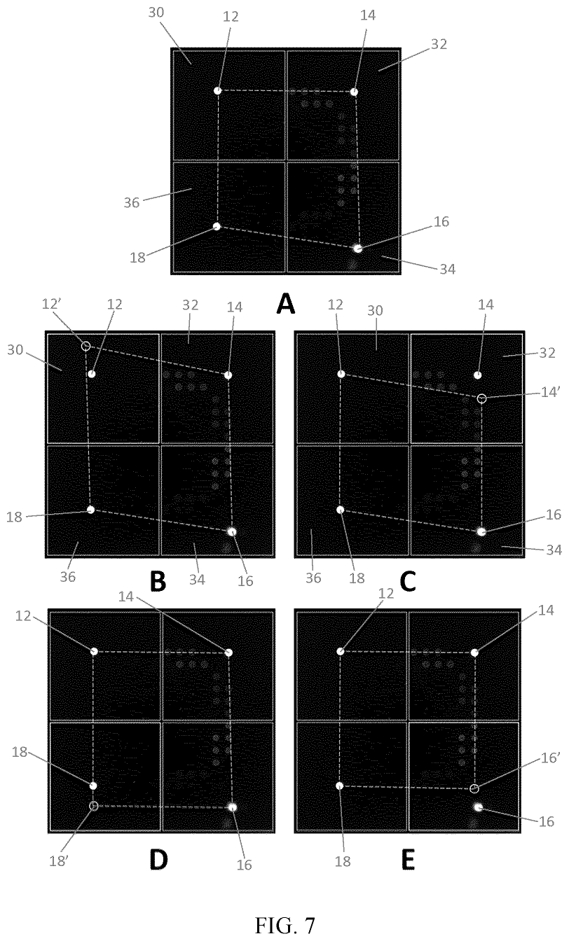

Step 9 referred to in FIG. 3 is the process of iteratively resetting each UDZ as active and removing all FMs within it. The application of this process is illustrated with reference to FIGS. 7A to 7E. In the example of four FM spots shown in FIG. 7A, one ‘true’ FM spot 12 is detected in upper left User-Defined Zone 30, FM spot 14 is located in the upper right User-Defined Zone 32 and FM spot 18 is located in the lower left User-Defined Zone 36. However, the ‘true’ FM spot in the lower right User-Defined Zone 34 is missing whereas a circular artifact 16 is falsely identified as an FM spot. A fitting error for a quadrilateral formed by straight lines connecting FM spot 12, FM spot 14, artifact 16 and FM spot 18 is calculated based on a comparison of the shape of the quadrilateral formed by straight lines connecting FM spot 12, FM spot 14, artifact 16 and FM spot 18 to an expected predefined square as illustrated in FIG. 8B. The algorithm for calculating the fitting error is discussed below.

The fitting error is compared to a predefined threshold. If the fitting error is greater than the predefined threshold, then the quadrilateral is not accepted as defining an AZ and the iteration process continues, as discussed below. The predefined threshold is set based on known tolerances of the manufacturing equipment used to produce the microarray. The determination of the predefined threshold is related primarily to the specification of the accuracy and precision of the dispensing technologies. The predefined threshold is therefore calculated directly from the specification of the manufacturing dispensing equipment. The location of each FM can be described relative to the origin as an (x, y) value, where x and y can be expressed in units of millimetres or microns. The expected location of the FMs is known, based on the manufacturing intent, and knowledge of the precision and accuracy specification of the manufacturing equipment. A predefined threshold can be set based on where the FM is expected to be from the parallelogram rule within the stated tolerances of the manufacturing equipment used for producing the microarray. For example, in certain applications, a tolerance of ±0.05 mm in (x,y) spatial location of the FM is used in calculating the threshold, taken directly from the specification of the manufacturing dispensing equipment.

As shown in FIG. 7B, the upper left User-Defined Zone 30 is then deactivated (the original FM spot 12 is turned off) and an imaginary FM spot 12′ is restored using the locations of FM spot 14, FM spot 18 and artifact 16 according to the parallelogram rule. A quadrilateral formed by straight lines connecting the imaginary FM spot 12′, FM spot 14, artifact 16, and FM spot 18 is fitted to a predefined square, which yields an error higher than the threshold. The same process is applied to other three zones (upper right UDZ 32 as shown in FIG. 7C, lower left UDZ 36 in FIG. 7D and lower right UDZ 34 in FIG. 7E) repeatedly. Only the restored imaginary FM spot 16′ in lower right User-Defined Zone 34 (FIG. 7E) results in a quadrilateral formed by straight lines connecting FM spots 12, 14, 16′, 18 having a fitting error that is lower than the predefined threshold. Consequently, FM spots 12, 14, 16′, 18 in FIG. 7E are exported as final FM spots. This results in the conclusion of the iteration step 9 represented in FIG. 3. The robust FM spot detection procedure then moves back to step 5 as demonstrated in FIG. 3.

The fitting error calculation for an example of four FM spots and a square predefined shape is calculated as follows:

FIG. 8A shows a possible combination of four FM spots with coordinates FM1—(x₁, y₁), FM2—(x₂, y₂), FM3—(x₃, y₃) and FM4—(x₄, y₄) in a cartesian coordinate system. Six characteristic lengths (four side lengths L₁₂, L₂₄, L₃₄, L₁₃ and two diagonal lengths L₁₄, L₂₃) of the quadrilateral of these spots are calculated as follows:

$${L}_{12} = \sqrt{{( {x}_{1} - {x}_{2} )}^{2} + {( {y}_{1} - {y}_{2} )}^{2}} , \\ {L}_{24} = \sqrt{{( {x}_{2} - {x}_{4} )}^{2} + {( {y}_{2} - {y}_{4} )}^{2}} , \\ {L}_{34} = \sqrt{{( {x}_{3} - {x}_{4} )}^{2} + {( {y}_{3} - {y}_{4} )}^{2}} , \\ {L}_{13} = \sqrt{{( {x}_{1} - {x}_{3} )}^{2} + {( {y}_{1} - {y}_{3} )}^{2}} , \\ {L}_{14} = \sqrt{{( {x}_{1} - {x}_{4} )}^{2} + {( {y}_{1} - {y}_{4} )}^{2}} , \\ {L}_{23} = \sqrt{{( {x}_{2} - {x}_{3} )}^{2} + {( {y}_{2} - {y}_{3} )}^{2}} .$$

Then, the sum of squared differences of characteristic lengths between this quadrilateral and a predefined square with side length a (shown in FIG. 8B) is derived as:

$${\sum }_{i} {( Δ {L}_{i} )}^{2} = {( {L}_{12} - a )}^{2} + {( {L}_{24} - a )}^{2} + {( {L}_{34} - a )}^{2} + {( {L}_{13} - a )}^{2} + {( {L}_{14} - \sqrt{2} a )}^{2} + {( {L}_{23} - \sqrt{2} a )}^{2} .$$

Finally, the sum of squared differences of characteristic lengths is normalized with respect to the scale of predefined square to obtain the fitting error:

$$Err = \frac{{{Σ}_{i} ( Δ {L}_{i} )}^{2}}{4 \times {a}^{2} + 2 \times {( \sqrt{2} a )}^{2}} = \frac{{{Σ}_{i} ( Δ {L}_{i} )}^{2}}{8 {a}^{2}} .$$

A final rotation check is carried out after the detection of the FM spots. FIG. 9A shows an example of rotated microarray image in which the FM spots FM1 90, FM2 92, FM3 94 and FM4 96 are correctly detected through robust FM spots detection. A rotational angle between a line 98 through FM1 90 and FM4 96 and a vertical line 100 is calculated as α₁. α₂ denotes a rotational angle between a line 102 through FM3 94 and FM4 96 and a horizontal line 104. Similarly, the other two rotational angles (α₃ and α₄) are obtained. α₃ denotes a rotational angle between a line 106 through FM3 94 and FM2 92 and a vertical line 108. α₄ denotes a rotational angle between a line 110 through FM1 90 and FM2 92 and a horizontal line 112. A rotational angle of microarray (α) is estimated as the average value of α₁, α₂, α₃ and α₄:

$$α = \frac{{α}_{1} + {α}_{2} + {α}_{3} + {α}_{4}}{4} .$$

In the example of FIG. 9A, a microarray rotational angle of around −11.02 degrees (negative value means clockwise or rotational direction) is estimated, hence the microarray image is rotated in an opposite rotational or counter-clockwise direction by 11.02 degrees to restore its normal condition. Finally, as shown in FIG. 9B, gridding and subsequent spot finding algorithms are applied to the restored image and MFIs of sensor spots 10 are correctly measured regardless of irregularity due to rotation.

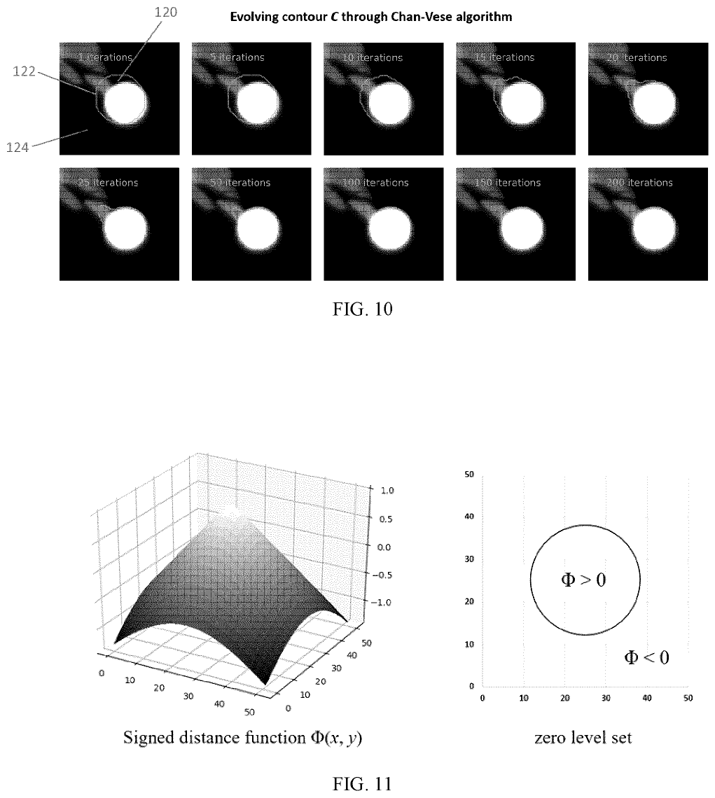

Spot finding algorithms have been developed through a novel image processing approach referred to as the Chan-Vese image segmentation. The Chan-Vese image segmentation improves on conventional methods in terms of dealing with blurred boundary, noisy image background and computation speed. Through the implementation of active contour and initial level set in spot finding, valid spot regions can be captured while excluding features which do not belong to the actual printed spot region, such as image background, artifacts, damaged sub-region etc. The Chan-Vese approach redefines the image segmentation problem as an energy minimization problem. As shown in the top-left inset in FIG. 10, the region 120 inside curve (C) 122 represents the spot region while the region 124 outside curve (C) denotes the background. The ultimate goal is to search a curve in such a way that both the variation of pixel intensities inside the curve and the variation of pixel intensities outside the curve are minimized. Mathematically, the object of Chan-Vese algorithm is to minimize the energy functional F(C), expressed as:

$$F ( C ) = μ \cdot Length ( C ) + v \cdot Area ( inside ( C ) ) + {λ}_{1} {\int }_{inside ( C )} {\vert {u}_{0} ( x , y ) - {c}_{1} \vert}^{2} dxdy + {λ}_{2} {\int }_{outside ( C )} {\vert {u}_{0} ( x , y ) - {c}_{2} \vert}^{2} dxdy , \\ {c}_{1} = \frac{{\int }_{inside ( C )} {u}_{0} ( x , y ) dxdy}{Area ( inside ( C ) )} , \\ {c}_{2} = \frac{{\int }_{outside ( C )} {u}_{0} ( x , y ) dxdy}{Area ( outside ( C ) )} ,$$

where c₁ and c₂ denote the average pixel intensity inside C and average pixel intensity outside C, respectively, u₀(x, y) denotes the pixel intensity of raw image, μ the length weight parameter, v the area weight parameter (usually set as zero), λ₁ the ‘difference from average’ weight parameter for the region inside C and λ₂ the ‘difference from average’ weight parameter for region outside C. Instead of searching the solution C which minimizes the energy functional, the problem can be simplified through a level set formulation. Given a contour C, Φ(x, y) is defined as the signed distance function from C, where the value of Φ(x, y) is positive inside C (negative outside C). Thus, the contour C can be formulated as the zero level set of Φ(x, y). An example of signed distance function and its zero level set (a circle) is shown in FIG. 11. The energy functional F(C) can be re-written in terms of Φ(x, y) only (v=0):

$$F ( Φ ) = μ \cdot \int δ ( Φ ( x , y ) ) \vert ∇ Φ ( x , y ) \vert dxdy + {λ}_{1} \int {\vert {u}_{0} ( x , y ) - {c}_{1} \vert}^{2} H ( Φ ( x , y ) ) dxdy + {λ}_{2} \int {\vert {u}_{0} ( x , y ) - {c}_{2} \vert}^{2} ( 1 - H ( Φ ( x , y ) ) ) dxdy , \\ {c}_{1} = \frac{\int {u}_{0} ( x , y ) H ( Φ ( x , y ) ) dxdy}{\int H ( Φ ( x , y ) ) dxdy} , \\ {c}_{2} = \frac{\int {u}_{0} ( x , y ) ( 1 - H ( Φ ( x , y ) ) ) dxdy}{\int ( 1 - H ( Φ ( x , y ) ) ) dxdy} ,$$

where δ(x) is the Dirac delta function and H(z) denotes the Heaviside function:

$$H ( z ) = \{ \begin{matrix}1 ( z \geq 0 ) \\ 0 ( z < 0 ) .\end{matrix}$$

Given an initial Φ(x, y, 0)=Φ₀(x, y), the evolution of Φ(x, y, t) which minimizes the energy functional F(C) is governed by a partial differential equation (PDE) using Euler-Lagrange equations and the gradient-descent method (t is an artificial time):

$$\frac{\partial Φ}{\partial t} = δ ( Φ ) ( μ \cdot div ( \frac{∇ Φ}{\vert ∇ Φ \vert} ) - {{λ}_{1} ( {u}_{0} - {c}_{1} )}^{2} + {{λ}_{2} ( {u}_{0} - {c}_{2} )}^{2} ) = δ ( Φ ) ( μ \cdot κ ( Φ ) - {{λ}_{1} ( {u}_{0} - {c}_{1} )}^{2} + {{λ}_{2} ( {u}_{0} - {c}_{2} )}^{2} ) , \\ Φ ( x , y , 0 ) = {Φ}_{0} ( x , y ) ,$$

where κ(Φ) represents the curvature of evolving contour C:

$$κ ( Φ ) = \frac{{Φ}_{xx} {Φ}_{y}^{2} - 2 {Φ}_{xy} {Φ}_{x} {Φ}_{y} + {Φ}_{yy} {Φ}_{x}^{2}}{{( {Φ}_{x}^{2} + {Φ}_{y}^{2} )}^{3 / 2}} .$$

Details of the numerical implementation of Chan-Vese algorithm can be found in a paper published by Getreuer (Chan-Vese Segmentation, Image Processing On Line, 2 (2012), pp 214-224). In the implementation of the present disclosure, the initial Φ₀(x, y) is defined by a signed distance function with a circle zero level set as schematically shown in FIG. 11. Through an iterative process using the Chan-Vese algorithm, Φ(x, y, t) evolves until a convergence criterion is reached. FIG. 10 shows an example of a spot-finding process through the iterative Chan-Vese algorithm. At nth iteration, the spot (foreground) region is represented by the area where Φ(x, y, t) is positive (within curve C) and the area where Φ(x, y, t) is negative (outside curve C) indicates the background region. The contour (curve C) shows the boundaries where Φ(x, y, t) equals zero. Initially, the spot region is set as the area within a predefined circle positioned at the image center through a circle zero level set. Governed by the PDE described above, curve C evolves as the ‘real’ spot region is gradually captured. Usually, by the 200th iteration (and often earlier), a convergence criterion is reached and thus the iteration process terminates, which exports the final segmentation result. The spot MFI is calculated as the average pixel intensities of the foreground region within curve C.

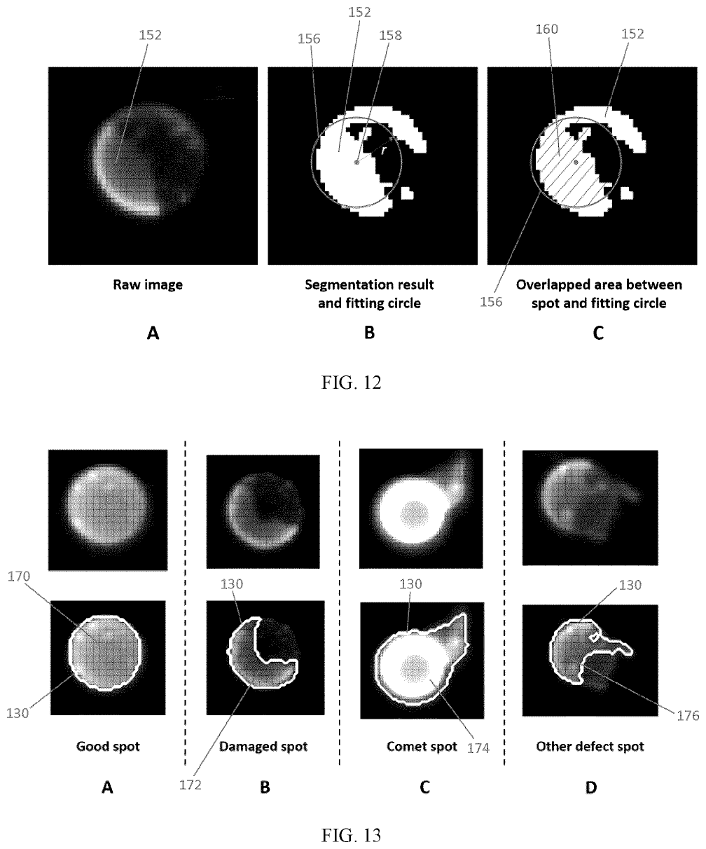

The segmentation result is expressed as a binary image. It is necessary to perform a geometrical check of the spot region to rule out defect spots from manufacturing. In the case of the microarray produced by printing droplets onto optically-transparent substrate, the predefined geometry of spots is circular due to the minimization of surface energy. Therefore, the circularity of spot regions is a crucial indicator of spot quality. FIG. 12 shows an example of segmentation result (FIG. 12B) from a raw image of a damaged spot 152 (FIG. 12A) and how the circularity calculation is carried out. FIG. 12B shows the damaged spot 152 with a fitting circle 156 and centroid 158. FIG. 12C shows an overlapped area 160 between the damaged spot 152 and the fitting circle 156. The proposed algorithm for circularity calculation is as follows:
1. Compute the total number of white pixels (i.e., area of spot region), s and centroid of the foreground geometry, p_{c}(x, y);
2. Compute the radius of a fitting circle with the same size as foreground, r=(s/π)^{1/2};
3. Create a fitting circle with radius r centered at the location p_{c}(x, y), and compute the number of pixels within the overlapped area between spot (foreground) and fitting circle, s*
4. Calculate the circularity value as G_{circ}=s*/s.

The calculated circularity value using the algorithm is within a range of [0, 1]. Circular spots (high-quality spots) produce concentric fitting circles 70, 72, as illustrated in FIG. 2 by way of example, with similar sizes, thus yielding high circularity values (close or equal to 1). However, spots with irregular shapes (defect spots) generate eccentric fitting circles which are either much larger or smaller compared to the regular spot sizes, resulting in low circularity values. FIG. 13 demonstrates some examples of possible morphologies of fluorescent spots. The images in the first row are raw images of individual spots generated by a scanner and the images in the second row show the identified spot regions (region within fitting curve 130) through the spot-finding algorithm based on active-contour segmentation. Damaged spots, comet spots (i.e., spots with flaring tails) or other defect spots have low circularity values and this approach identifies them as outliers when the circularity is below a user defined threshold consistent with the manufacturing capability. In the present cases, ≤0.9 is used as the threshold. FIG. 13A shows a good spot 170 within the fitting curve 130. FIG. 13B shows a further damaged spot 172 within the fitting curve 130. FIG. 13C shows a comet spot 174 within the fitting curve 130. FIG. 13D shows another defect spot 176 within the fitting curve 130.

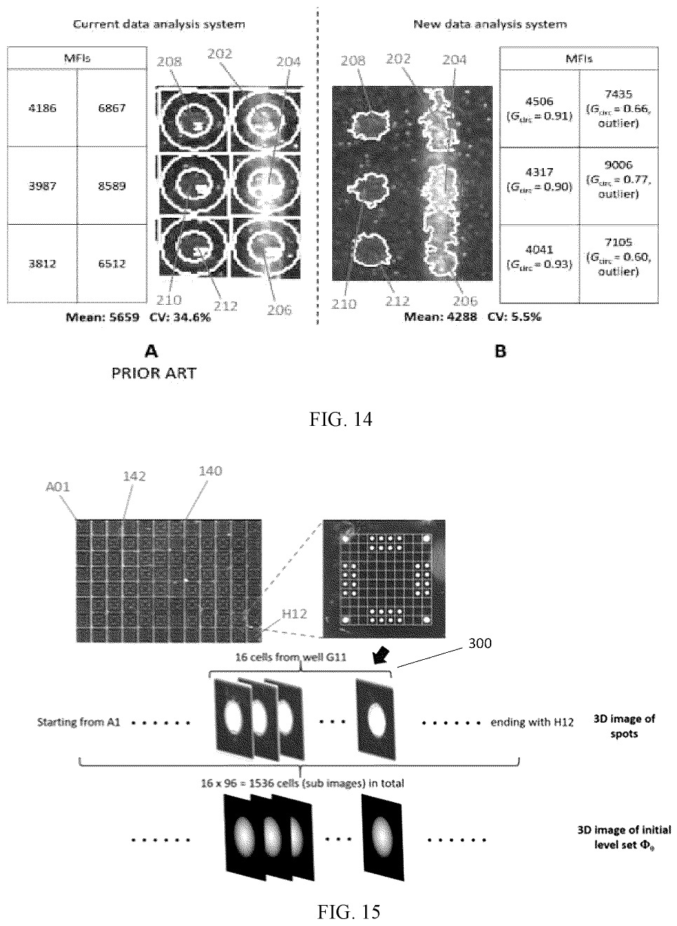

FIGS. 14A and 14B compare results at relatively low assay concentrations. As shown by the contrast-enhanced inset, among six replicates, three spots 202, 204, 206 in a second column are ‘smeared’ as shown in FIG. 14A while the other three spots 208, 210, 212 in a first column in FIG. 14A are easily detectable. A standard approach results in the spot MFIs in the second column having significant variation (standard deviation: 34.6%). The present method has improved results (standard deviation: 5.5%). As shown in FIG. 14B using the system of the present disclosure, the same three spots 202, 204, 206 in a second column are ‘smeared’ as shown in FIG. 14B while the other three spots 208, 210, 212 in a first column in FIG. 14B are easily detectable. The results obtained according to the method of the present disclosure demonstrates improved edge detection. Circularity tests according to the present method provide excellent feedback on data quality. This has resulted in a significant improvement in the precision of spot MFI measurements.

Using a standard approach, the image processing steps for a microarray plate through CPU sequential computation are as follows:
1. Apply gridding to contents of a well of an assay plate having microarrays of sensor spots printed thereon;
2. Apply spot-finding algorithms (Chan-Vese) and subsequent quality checks to all segmented cells;
3. Repeat steps 1-2 for all wells.

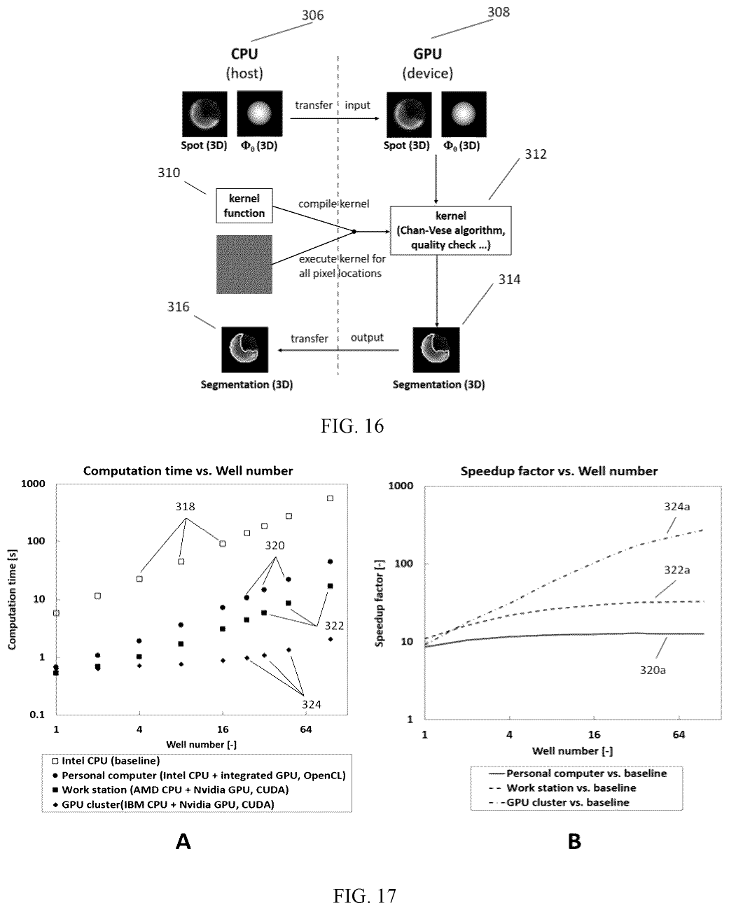

A faster approach is provided which combines the fast-processing speed in sequential computing of CPU and the parallel nature for simultaneous analysis of image series of a a graphic processing unit (GPU). Since the gridding algorithm using robust detection of FM spots involves many sequential steps and branches, it is implemented on CPU to maximize its sequential processing speed. Tests show that the gridding of a standard 96-well plate takes an average time of 0.102 s (0.001 second per well) using a consumer-grade CPU (AMD Ryzen™ 7 3700X). After gridding, the microarray images are segmented into individual sub images 300 with the same dimension (e.g., 64×64 pixels) and each of them contains a spot and its background. The sub images are then stacked into a 3D image with a depth of total number of spots. FIG. 15 shows an example of the construction of 3D spot image 300 of a 96-well plate 140 (each well 142 contains 16 sensor spots). The 3D spot image 300 starts from the first in well A01 and ends with the last spot in well H12. In parallel, another 3D image with the same dimension as the 3D spot image is constructed using pre-defined identical initial level set Φ₀(x, y). FIG. 16 shows an overview of the workflow of the proposed approach for the parallel analysis of 3D spot image. A CPU-based program (e.g., Python) sets up the parallel platform (e.g., OpenCL/CUDA) and issues data transfers between the host (CPU) 306 and device (GPU) 308. A compiled GPU kernel of image processing algorithms 312 (e.g., Chan-Vese algorithm, quality check etc.) is executed simultaneously for all pixels of the 3D array on a GPU device. Practically, the constructed 3D arrays of both spots and initial level set Φ₀(x, y) using the CPU program are transferred to the GPU device. The spot-finding (Chan-Vese) and quality-check algorithms are applied to every pixel in parallel through a kernel function 310 on the GPU to generate a segmentation result 314, which is a 3D image with the same dimension and order as the input 3D spot image. Finally, a segmentation result 316 with corresponding quality checks is transferred back to the host, and the CPU program reports the outcome (spot MFI, circularity etc.). In summary, the image processing steps for the proposed approach combining both sequential CPU computing and parallel GPU computing are as follows:
1. Apply gridding to all wells to generate 3D arrays;
2. Apply spot-finding algorithms (Chan-Vese) and subsequent quality check to all pixels of the 3D array simultaneously.

The image-processing approach has been implemented and tested on a list of hardware combinations (CPU+GPU) as follows: a) personal computer (Intel® Core™ i7-8550U+Intel UHD Graphics 620, OpenCL platform); b) work station (AMD Ryzen™ 7 3700X+NVIDIA® GeForce® RTX 2080 Ti, CUDA platform); c) GPU cluster (IBM® POWER9 processor+NVIDIA® V100-SMX2-32 GB GPU). The tested results are shown in FIG. 17 where the computation time (data points, left vertical axis) and speedup factor (solid lines, right vertical axis) are plotted as a function of well number. The baseline 318 represents the data from a standard process purely using sequential CPU (Intel® Core™ i7-8550U) computation. The data points 320, 322, 324 show the computation time versus well number for different hardware combinations, while the corresponding solid lines 320a, 322a, 324a demonstrate the speedup factor (ratio of computation time using proposed approach to that of baseline) respectively. The results confirm that parallel implementation achieves a significant speedup. For example, for a standard 96-well plate the computation time of novel data-analysis routine using sequential implementation is 540 seconds whereas the parallel implementation reduces the time consumption down to 14 seconds in case of work station (2 seconds for GPU cluster). This implies that the proposed approach can be implemented whether in-house (e.g., work station) or using cloud-based routines (e.g., GPU cluster).

### EXAMPLES

### Example 1: Calculation of Fitting Error

Using the representation in FIG. 8A, the image shown in FIG. 7A can be placed in a cartesian plane defined by axes x and y, with the origin (0, 0) at the lower left corner of the image. The fitting error for the quadrilateral formed by straight lines connecting FM spots 12, 14, 16, 18 shown in FIG. 7A is calculated according to the data shown in Table 1 below showing the coordinates of FM spots 12, 14, 16, 18:

TABLE 1
x, y coordinates of the FM's depicted in FIG. 7A

| | FM | Actual | | Expected | |
|---|---|---|---|---|---|
| FM id | (FIG. 7A) | x (mm) | y (mm) | x (mm) | y (mm) |
| FM1 | 12 | 0.500 | 7.500 | 0.500 | 7.500 |
| FM2 | 14 | 7.500 | 7.500 | 7.500 | 7.500 |
| FM4 | 16 | 7.600 | 0.200 | 7.500 | 0.500 |
| FM3 | 18 | 0.500 | 0.500 | 0.500 | 0.500 |

The location of each FM spot is described relative to the origin as an (x, y) value, where x and y are expressed in units of millimetres or microns. Representative measurements of the location of each FM spot in millimetres are set out in Table 1 under the heading “Actual”. The expected location of each of the FM spots is known, based on the manufacturing intent, and knowledge of the precision and accuracy specification of the manufacturing equipment. These measurements of the expected location of each FM spot are represented in Table 1 under the heading “Expected” as the expected coordinates.

From inspection of the actual and expected coordinates, it is clear that the actual location of FM4 spot 16 deviates from the expected location.

Additional information can be gained from the expected location of the FM spots, spatially related to each other via a predefined square, as shown in FIG. 8B, which identifies the length a for each of the sides of the square and the length of the diagonal as √2a.

The error function:

$$Err = \frac{{{Σ}_{i} ( Δ {L}_{i} )}^{2}}{4 \times {a}^{2} + 2 \times {( \sqrt{2} a )}^{2}}$$

makes use of the actual measured lengths Lᵢ between the FM spots and the expected, or known, value a from the predefined square.

Table 2 shows these measurements from that data for FIG. 7A above and the square of the difference between each actual and expected length for a=7.000 mm.

TABLE 2
a = 7.000

| | Actual | Expected | Delta\hat{ }2 |
|---|---|---|---|
| Length | (mm) | (mm) | (mm²) |
| L12 | 7.000 | 7.000 | 0.000 |
| L13 | 7.000 | 7.000 | 0.000 |
| L14 | 10.183 | 9.899 | 0.081 |
| L23 | 9.899 | 9.899 | 0.000 |
| L24 | 7.301 | 7.000 | 0.090 |
| L34 | 7.106 | 7.000 | 0.011 |
| Err | | | 1.116 |

The resulting error function is a dimensionless term that can be compared to a pre-defined threshold.

### Example 2: Calculation of Predefined Threshold

The threshold may be derived from known tolerances in the manufacturing of the microarray, related primarily to the specification of the accuracy and precision of the dispensing technologies.

In the following example, a tolerance of ±0.05 mm in (x,y) spatial location of the FM spot is used, taken directly from the specification of the manufacturing dispensing equipment. A worst-case example is taken where each of the FM spot locations is at the boundary of the (x,y) tolerance to maximize the geometry and size of the threshold square. Dimensions are provided in Table 3, and the working calculation in Table 4, using the error function described above.

TABLE 3

| | | |
|---|---|---|
| FM | Threshold | Expected |

| FM id | (FIG. 7A) | x | y | x | y |
|---|---|---|---|---|---|
| FM1 | 12 | 0.450 | 7.550 | 0.500 | 7.500 |
| FM2 | 14 | 7.550 | 7.550 | 7.500 | 7.500 |
| FM4 | 16 | 7.550 | 0.450 | 7.500 | 0.500 |
| FM3 | 18 | 0.450 | 0.450 | 0.500 | 0.500 |

TABLE 4
a = 7.000

| | Threshold | Expected | Delta\hat{ }2 |
|---|---|---|---|
| Length | (mm) | (mm) | (mm²) |
| L12 | 7.100 | 7.000 | 0.010 |
| L13 | 7.100 | 7.000 | 0.010 |
| L14 | 10.041 | 9.899 | 0.020 |
| L23 | 10.041 | 9.899 | 0.020 |
| L24 | 7.100 | 7.000 | 0.010 |
| L34 | 7.100 | 7.000 | 0.010 |
| Threshold | | | 0.049 |

Returning to the example of the calculation from FIG. 7A, the determined error function of 1.116 is greater than the threshold of 0.049, and consequently the iteration will proceed until the error function is less than or equal to the threshold.

While various aspects and embodiments have been disclosed herein, other aspects and embodiments are contemplated. The various aspects and embodiments disclosed herein are for purposes of illustration and are not intended to be limiting.

1. A method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps:
providing a fluorescent material that binds to the fiducial marker spots, the fiducial marker spots comprising a material which causes the fiducial marker spots to have a detectable fluorescent intensity when contacted with the fluorescent material;
generating an image of the microarray substrate;
adding visible lines in the form of a grid on the image such that the grid forms a plurality of individual cells, the cells being sized to contain at most one sensor spot or fiducial marker spot;
dividing the image into four user defined zones, a first user defined zone being an upper left zone of the image, a second user defined zone being an upper right zone of the image, a third user defined zone being a lower right zone of the image, and a fourth user defined zone being a lower left zone of the image;
searching for the detection of fiducial marker spots in each of the user defined zones;
determining the detection of a fiducial marker spot in each of the user defined zones whereby an imaginary line connecting the four fiducial marker spots detected meets a user defined shape, the user defined shape being a perfect square; and
determining the location of a boundary around the analysis zone based on the location of the fiducial marker spots.

2. A method according to claim 1 wherein a rotation check is carried out based on the location of the fiducial marker spots according to the following steps:
measuring a first angle α₁ between a) a line joining a fiducial marker spot located in the first user defined zone and a fiducial marker spot located in the fourth user defined zone and b) a vertical line extending from a top to a bottom of the first user defined zone;
measuring a second angle α₂ between a) a line joining a fiducial marker spot located in the fourth user defined zone and a fiducial marker spot located in the third user defined zone and b) a horizontal line extending from a left side to a right side of the fourth user defined zone;
measuring a third angle α₃ between a) a line joining a fiducial marker spot located in the third user defined zone and a fiducial marker spot located in the second user defined zone and b) a vertical line extending from a top to a bottom of the third user defined zone;
measuring a fourth angle α₄ between a) a line joining a fiducial marker spot located in the second user defined zone and a fiducial marker spot located in the first user defined zone and b) a horizontal line extending from a left side to a right side of the second user defined zone;
calculating a rotational angle of microarray (α) according to the following formula:
$$α = \frac{{α}_{1} + {α}_{2} + {α}_{3} + {α}_{4}}{4} ;$$
and
rotating the image in an opposite rotational direction by α degrees.

3. A method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps:
providing a fluorescent material that binds to the fiducial marker spots, the fiducial marker spots comprising material which causes the fiducial marker spots to have a detectable fluorescent intensity when contacted with the fluorescent material;
generating an image of the microarray substrate;
adding visible lines in the form of a grid on the image such that the grid forms a plurality of individual cells, the cells being sized to contain at most one sensor spot or fiducial marker spot;
dividing the image into four user defined zones, a first user defined zone being an upper left zone of the image, a second user defined zone being an upper right zone of the image, a third user defined zone being a lower right zone of the image, and a fourth user defined zone being an lower left zone of the image;
searching for the detection of fiducial marker spots in each of the user defined zones, whereby one fiducial marker spot is located in each of three of the four user defined zones and a fiducial marker spot and an artifact spot are detected in one of the four of the user defined zones;
determining which of the fiducial marker spot and an artifact spot detected in the one of the four of the user defined zones is a true fiducial marker spot according to the following steps: drawing two possible quadrilaterals by connecting with an imaginary line the spots in each user defined zone with the spots in the other user defined zones with the rule that spots in a single user defined zone cannot be connected;
determining which of the two quadrilaterals has a lower residual error relative to a predefined threshold set based on known tolerances of the manufacturing equipment used to produce the microarray;
selecting the spot in the one of the four of the user defined zones being part of the quadrilateral that has a lower residual error as the true fiducial marker spot; and
determining the location of a boundary around the analysis zone based on the location of the fiducial marker spots detected and the true fiducial marker spot determined.

4. A method according to claim 3 wherein a rotation check is carried out based on the location of the fiducial marker spots according to the following steps:
measuring a first angle α₁ between a) a line joining a fiducial marker spot located in the first user defined zone and a fiducial marker spot located in the fourth user defined zone and b) a vertical line extending from a top to a bottom of the first user defined zone;
measuring a second angle α₂ between a) a line joining a fiducial marker spot located in the fourth user defined zone and a fiducial marker spot located in the third user defined zone and b) a horizontal line extending from a left side to a right side of the fourth user defined zone;
measuring a third angle α₃ between a) a line joining a fiducial marker spot located in the third user defined zone and a fiducial marker spot located in the second user defined zone and b) a vertical line extending from a top to a bottom of the third user defined zone;
measuring a fourth angle α₄ between a) a line joining a fiducial marker spot located in the second user defined zone and a fiducial marker spot located in the first user defined zone and b) a horizontal line extending from a left side to a right side of the second user defined zone;
calculating a rotational angle of microarray (α) according to the following formula:
$$α = \frac{{α}_{1} + {α}_{2} + {α}_{3} + {α}_{4}}{4} ;$$
and
rotating the image in an opposite rotational direction by α degrees.

5. A method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps:
providing a fluorescent material that binds to the fiducial marker spots, the fiducial marker spots comprising material which causes the fiducial marker spots to have a detectable fluorescent intensity when contacted with the fluorescent material;
generating an image of the microarray substrate;
adding visible lines in the form of a grid on the image such that the grid forms a plurality of individual cells, the cells being sized to contain at most one sensor spot or fiducial marker spot;
dividing the image into four user defined zones, a first user defined zone being an upper left zone of the image, a second user defined zone being an upper right zone of the image, a third user defined zone being a lower right zone of the image, and a fourth user defined zone being an lower left zone of the image;
searching for the detection of fiducial marker spots in each of the user defined zones, whereby one fiducial marker spot is located in each of three of the four user defined zones and no fiducial marker spot is detected in one of the four of the user defined zones;
assigning a location of a projected fiducial marker spot in the one of the four of the user defined zones where no fiducial marker spot is detected by drawing a parallelogram connecting the fiducial marker spots located in the three of the four user defined zones and the projected fiducial marker spot according to the parallelogram rule; and
determining the location of a boundary around the analysis zone based on the location of the fiducial marker spots detected and the projected fiducial marker spot.

6. A method according to claim 5 wherein a rotation check is carried out based on the location of the fiducial marker spots according to the following steps:
measuring a first angle α₁ between a) a line joining a fiducial marker spot located in the first user defined zone and a fiducial marker spot located in the fourth user defined zone and b) a vertical line extending from a top to a bottom of the first user defined zone;
measuring a second angle α₂ between a) a line joining a fiducial marker spot located in the fourth user defined zone and a fiducial marker spot located in the third user defined zone and b) a horizontal line extending from a left side to a right side of the fourth user defined zone;
measuring a third angle α₃ between a) a line joining a fiducial marker spot located in the third user defined zone and a fiducial marker spot located in the second user defined zone and b) a vertical line extending from a top to a bottom of the third user defined zone;
measuring a fourth angle α₄ between a) a line joining a fiducial marker spot located in the second user defined zone and a fiducial marker spot located in the first user defined zone and b) a horizontal line extending from a left side to a right side of the second user defined zone;
calculating a rotational angle of microarray (α) according to the following formula:
$$α = \frac{{α}_{1} + {α}_{2} + {α}_{3} + {α}_{4}}{4} ;$$
and
rotating the image in an opposite rotational direction by α degrees.

7. A method of locating a plurality of spaced apart fiducial marker spots printed on a microarray substrate upon which sensor spots including a biomarker for diagnostic purposes may be printed, the spaced apart fiducial marker spots defining a periphery of an analysis zone of the microarray substrate, the method comprising the following steps:
providing a fluorescent material that binds to the fiducial marker spots, the fiducial marker spots comprising material which causes the fiducial marker spots to have a detectable fluorescent intensity when contacted with the fluorescent material;
generating an image of a portion microarray substrate comprising the analysis zone;
adding visible lines in the form of a grid on the image such that the grid forms a plurality of individual cells, the cells being sized to contain at most one sensor spot or fiducial marker spot;
dividing the image into four user defined zones, a first user defined zone being an upper left zone of the image, a second user defined zone being an upper right zone of the image, a third user defined zone being a lower right zone of the image, and a fourth user defined zone being a lower left zone of the image;
searching for the detection of fiducial marker spots in each of the user defined zones, whereby one fiducial marker spot is detected in each of three of the four user defined zones and an artifact spot is detected in one of the four user defined zones;
iteratively, for each of the four user defined zones, deactivating the spot of the user defined zone according to the following steps:
deactivating the spot detected in the user defined zone and assigning a location of a projected fiducial marker spot in the user defined zone where the spot is deactivated;
connecting with an imaginary line the three spots of the non-deactivated user defined zones with the projected fiducial marker spot to form a quadrilateral;
calculating a fitting error of the quadrilateral based on a comparison of the shape of the quadrilateral formed by the imaginary line to an expected predefined perfect square; and
comparing the fitting error to a predefined threshold wherein the predefined threshold is set based on known tolerances of the manufacturing equipment used to produce the microarray;
calculating among quadrilaterals generated iteratively, a quadrilateral with a fitting error that is lower than the predefined threshold;
selecting a projected fiducial marker spot of a quadrilateral with a fitting error that is lower than the predefined threshold as being a true fiducial marker spot and disregarding a spot detected in a user defined zone of the selected projected fiducial marker spot as being an artifact; and
determining the location of a boundary around the analysis zone based on the location of the fiducial marker spots detected and a projected fiducial marker spot.

8. The method of claim 7 wherein the fitting error is calculated according to the following steps:
assigning coordinates (x₁, y₁), to the fiducial marker spot in the first user defined zone; assigning coordinates (x₂, y₂) to the fiducial marker spot in the second user defined zone;
assigning coordinates (x₃, y₃) to the fiducial marker spot in the third user defined zone; assigning coordinates (x₄, y₄) to the fiducial marker spot in the fourth user defined zone in a cartesian coordinate system;
calculating four side lengths L₁₂, L₂₄, L₃₄, L₁₃ and two diagonal lengths L₁₄, L₂₃ of a quadrilateral formed by connecting the four fiducial marker spots as follows:
$${L}_{12} = \sqrt{{( {x}_{1} - {x}_{2} )}^{2} + {( {y}_{1} - {y}_{2} )}^{2}} , \\ {L}_{24} = \sqrt{{( {x}_{2} - {x}_{4} )}^{2} + {( {y}_{2} - {y}_{4} )}^{2}} , \\ {L}_{34} = \sqrt{{( {x}_{3} - {x}_{4} )}^{2} + {( {y}_{3} - {y}_{4} )}^{2}} , \\ {L}_{13} = \sqrt{{( {x}_{1} - {x}_{3} )}^{2} + {( {y}_{1} - {y}_{3} )}^{2}} , \\ {L}_{14} = \sqrt{{( {x}_{1} - {x}_{4} )}^{2} + {( {y}_{1} - {y}_{4} )}^{2}} , \\ {L}_{23} = \sqrt{{( {x}_{2} - {x}_{3} )}^{2} + {( {y}_{2} - {y}_{3} )}^{2}} ;$$
calculating a sum of squared differences of lengths between the quadrilateral and a predefined perfect square with side length a according to the following formula:
$${\sum }_{i} {( Δ {L}_{i} )}^{2} = {( {L}_{12} - a )}^{2} + {( {L}_{24} - a )}^{2} + {( {L}_{34} - a )}^{2} + {( {L}_{13} - a )}^{2} + {( {L}_{14} - \sqrt{2} a )}^{2} + {( {L}_{23} - \sqrt{2} a )}^{2} ;$$
and
calculating a sum of squared differences of lengths of the lines of the quadrilateral to obtain the fitting error according to the following formula:
$$Err = \frac{{{Σ}_{i} ( Δ {L}_{i} )}^{2}}{4 \times {a}^{2} + 2 \times {( \sqrt{2} a )}^{2}} = \frac{{{Σ}_{i} ( Δ {L}_{i} )}^{2}}{8 {a}^{2}} .$$

9. A method according to claim 7 wherein a rotation check is carried out based on the location of the fiducial marker spots according to the following steps:
measuring a first angle α₁ between a) a line joining a fiducial marker spot located in the first user defined zone and a fiducial marker spot located in the fourth user defined zone, and b) a vertical line extending from a top to a bottom of the first user defined zone;
measuring a second angle α₂ between a) a line joining a fiducial marker spot located in the fourth user defined zone and a fiducial marker spot located in the third user defined zone and b) a horizontal line extending from a left side to a right side of the fourth user defined zone;
measuring a third angle α₃ between a) a line joining a fiducial marker spot located in the third user defined zone and a fiducial marker spot located in the second user defined zone and b) a vertical line extending from a top to a bottom of the third user defined zone;
measuring a fourth angle α₄ between a) a line joining a fiducial marker spot located in the second user defined zone and a fiducial marker spot located in the first user defined zone and b) a horizontal line extending from a left side to a right side of the second user defined zone;
calculating a rotational angle of microarray (α) according to the following formula:
$$α = \frac{{α}_{1} + {α}_{2} + {α}_{3} + {α}_{4}}{4} ;$$
and
rotating the image in an opposite rotational direction by α degrees.

10. A method of identifying a spot edge contour of a sensor spot printed on a microarray substrate such that both a variation of pixel intensities inside a contour of a curve C and a variation of pixel intensities outside the curve C are minimized for measuring a Mean Fluorescence Intensity (MFI) of the sensor spot within the contour comprising the following steps:
providing a fluorescent material that binds to the sensor spots, the sensor spots comprising a material which causes the sensor spots to have a detectable fluorescent intensity when contacted with the fluorescent material;
generating an image of the microarray substrate;
applying the circular curve C around the image of the sensor spot wherein region inside the curve C represents a sensor spot region while the region outside the curve C denotes a background region;
defining the contour of the curve C as Φ(x, y) being defined as a signed distance function from C, where the value of Φ(x, y) is positive inside the curve C and is negative outside the curve C;
applying a level set formulation according to the following steps:
calculating an energy functional F(C) in terms of Φ(x, y) only (v=0) as follows:
$$F ( Φ ) = μ \cdot \int δ ( Φ ( x , y ) ) \vert ∇ Φ ( x , y ) \vert dxdy + {λ}_{1} \int {\vert {u}_{0} ( x , y ) - {c}_{1} \vert}^{2} H ( Φ ( x , y ) ) dxdy + {λ}_{2} \int {\vert {u}_{0} ( x , y ) - {c}_{2} \vert}^{2} ( 1 - H ( Φ ( x , y ) ) ) dxdy , \\ {c}_{1} = \frac{\int {u}_{0} ( x , y ) H ( Φ ( x , y ) ) dxdy}{\int H ( Φ ( x , y ) ) dxdy} , \\ {c}_{2} = \frac{\int {u}_{0} ( x , y ) ( 1 - H ( Φ ( x , y ) ) ) dxdy}{\int ( 1 - H ( Φ ( x , y ) ) ) dxdy} ,$$
where δ(x) is the Dirac delta function and H(z) denotes the Heaviside function:
$$H ( z ) = \{ \begin{matrix}1 ( z \geq 0 ) \\ 0 ( z < 0 )\end{matrix}$$
wherein given an initial Φ(x, y, 0)=Φ₀(x, y), an evolution of Φ(x, y, t) which minimizes the energy functional F(C) is governed by a partial differential equation (PDE) using Euler-Lagrange equations and the gradient-descent method (t is an artificial time):
$$\frac{\partial Φ}{\partial t} = δ ( Φ ) ( μ \cdot div ( \frac{∇ Φ}{\vert ∇ Φ \vert} ) - {{λ}_{1} ( {u}_{0} - {c}_{1} )}^{2} + {{λ}_{2} ( {u}_{0} - {c}_{2} )}^{2} ) = δ ( Φ ) ( μ \cdot κ ( Φ ) - {{λ}_{1} ( {u}_{0} - {c}_{1} )}^{2} + {{λ}_{2} ( {u}_{0} - {c}_{2} )}^{2} ) , \\ Φ ( x , y , 0 ) = {Φ}_{0} ( x , y ) ,$$
where κ(Φ) represents the curvature of evolving contour C:
$$κ ( Φ ) = \frac{{Φ}_{xx} {Φ}_{y}^{2} - 2 {Φ}_{xy} {Φ}_{x} {Φ}_{y} + {Φ}_{yy} {Φ}_{x}^{2}}{{( {Φ}_{x}^{2} + {Φ}_{y}^{2} )}^{3 / 2}} ;$$
determining the contour of the curve C as a zero level set of Φ(x, y);
applying an iterative process using a Chan-Vese active-contour algorithm which specializes in the partition of images without clear edges by evolving Φ(x, y, t) a plurality of times until a convergence criterion is reached, wherein the curve C shows boundaries where Φ(x, y, t) equals zero; and
calculating the sensor spot MFI as the average pixel intensities of a foreground region within the contour of the curve C.

11. A method according to claim 10 further comprising the step of performing a geometrical check of the sensor spot region to rule out defect spots from manufacturing according to the following steps:
computing the total number of white pixels in an area of the spot region within the contour of the curve C, s and centroid of the foreground geometry, p_{c}(x, y);
computing the radius of a fitting circle with the same size as foreground, r=(s/π)^{1/2};
creating a fitting circle with radius r centered at a location p_{c}(x, y), and computing a number of pixels within an overlapped area between the spot (foreground) and the fitting circle, s*;
calculating the circularity value as G_{circ}=s*/s; and
selecting sensor spots with circularity values close or equal to 1.

12. A method of processing images of sensor spots printed on a microarray substrate wherein the sensor spots emit light pixels for detection of the sensor spots, said method comprising the following steps:
employing a central processing unit (CPU) for detecting a sensor spot region containing the sensor spots to be analyzed through a gridding algorithm;
segmenting microarray images of the sensor spots into individual sub images with a same dimension wherein each sub image contains a sensor spot and a background of the sensor spot;
stacking the sub images into an array of 2D images with a depth of a total number of sensor spots;
in parallel constructing another 3D array with the same dimension using a pre-defined identical initial level set Φ₀(x, y) wherein Φ(x, y) is defined as the signed distance function from C, where the value of Φ(x, y) is positive inside C and negative outside C, C being a circular curve around the sensor spot; and
transferring constructed 3D arrays of both sensor spots and initial level set Φ₀(x, y) using a CPU program to a graphic processing unit (GPU) device.

13. The method according to claim 12 further comprising the steps of applying a spot-finding method using a Chan-Vese segmentation algorithm and a quality-check process to every pixel in parallel through a kernel function on a GPU to generate the segmentation result.

14. The method according to claim 13 wherein the segmentation result is a 3D image with the same dimension and order as the input 3D spot image.

15. The method according to claim 13 further comprising the step of transferring back the segmentation result with corresponding quality checks to the CPU for the reporting of results.
